(19) United States
(12) Patent Application Publication
(10) Pub. No.: US 2022/0226932 A1
(43) Pub. Date: Jul. 21, 2022

(54) OPTICAL PUNCHING OF MICROHOLES IN THIN GLASS

(71) Applicant: TRUMPF Laser- und Systemtechnik GmbH, Ditzingen (DE)

(72) Inventors: Jonas Kleiner, Leonberg (DE); Daniel Flamm, Ludwigsburg (DE); Myriam Kaiser, Heimsheim (DE)

(21) Appl. No.: 17/712,204

(22) Filed: Apr. 4, 2022

Related U.S. Application Data
(63) Continuation of application No. PCT/EP2020/077922, filed on Oct. 6, 2020.

(30) Foreign Application Priority Data
Oct. 11, 2019 (DE) 10 2019 127 514.8
Mar. 2, 2020 (DE) 10 2020 105 540.4

(51) Int. Cl. B23K 26/364; G02B 27/09; G02B 5/18; G02B 5/00; B23K 26/402; C03C 23/00

(52) U.S. Cl. CPC B23K 26/364; G02B 27/0944; C03C 23/0025; G02B 5/001; B23K 26/402; G02B 5/1866

(57) ABSTRACT

A method for selective laser-induced etching of a microhole into a workpiece includes creating a modification in the workpiece that extends from an entrance side to an exit side of the workpiece. The modification is created by a laser pulse that has an annular transverse intensity distribution. The modification delimites a cylindrical body from a residual material surrounding the modification. The method further includes introducing the workpiece with the modification into a wet-chemical etching bath for structurally separating the cylindrical body from the residual material.

### CROSS REFERENCE TO RELATED APPLICATIONS

This application is a continuation of International Application No. PCT/EP2020/077922 (WO 2021/069403 A1), filed on Oct. 6, 2020, and claims benefit to German Patent Applications No. DE 10 2019 127 514.8, filed on Oct. 11, 2019, and DE 10 2020 105 540.4, filed on Mar. 2, 2020. The aforementioned applications are hereby incorporated by reference herein.

### FIELD

Aspects of the present invention relate to a method for creating holes in a material. Aspects of the present invention also relate to a laser machining installation having a beam-shaping element.

### BACKGROUND

In transparent laser machining, laser radiation is used to create modifications in a material which is substantially transparent to the laser radiation and is referred to in the present disclosure as transparent material. Absorption of the laser radiation that occurs in the volume of the material (volume absorption for short) can be used for example for boring, for induced-voltage separation, for welding, for bringing about a modification of the refractive behavior, or for selective laser etching of transparent materials. In this respect, see for example the applicant's applications WO 2016/079062 A1, WO 2016/079062 A1 and WO 2016/079275 A1.

In these fields of use, it can be important to be able to suitably check both a geometry and the nature of the modification in the material. Apart from parameters such as laser wavelength, pulse shape over time, number of pulses, and pulse energy, the beam shape can be relevant here.

For example, glass modification processes based on ultrashort-pulse lasers can be carried out for the purpose of the separation or selective laser etching (SLE) of glass by means of elongate focal distributions. Elongate focal distributions are created e.g. using Bessel-beam-like beam profiles. Elongate focal distributions of this type can form elongate modifications in the material, which extend in the interior of the material in the propagation direction of the laser radiation.

Beam-shaping elements and optical setups, with which it is possible to provide slender beam profiles which are elongate in the beam propagation direction and have a high aspect ratio for the laser machining, are described e.g. in the abovementioned document WO 2016/079062 A1.

In the course of selective laser etching, microstructurings are created by modifications in the material that are introduced using a laser and by a subsequent wet-chemical etching process. In this respect, an aggressive etching medium breaks chemical bonds in the material to be machined, this being done substantially only in the regions of the introduced modification(s). Correspondingly, it is only there that the machined (modified) material detaches in the etching medium. In the case of wet-chemical etching methods of this type, the absolute etching rate depends inter alia on the etching temperature and the concentration of the etching liquid (the etch) and on the structural defects in the material to be etched (i.e. in the modifications).

### SUMMARY

Embodiments of the present invention provide a method for selective laser-induced etching of a microhole into a workpiece. The method includes creating a modification in the workpiece that extends from an entrance side to an exit side of the workpiece. The modification is created by a laser pulse that has an annular transverse intensity distribution. The modification delimites a cylindrical body from a residual material surrounding the modification. The method further includes introducing the workpiece with the modification into a wet-chemical etching bath for structurally separating the cylindrical body from the residual material.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic diagram of a laser system having a beam-shaping element for machining a workpiece with a focus zone extending through the workpiece;

FIGS. 2A to 2D show schematic representations for illustrating an areal phase distribution of a beam-shaping element for creating a focus zone in the form of a surface of a cylinder, and a continuously annular transverse intensity distribution;

FIGS. 3A and 3B show a transverse and a longitudinal calculated intensity distribution of a focus zone which is in the form of a surface of a cylinder and has a diameter of 10 p.m, as can be created in a material by means of a phase distribution of FIG. 2A;

FIGS. 3C and 3D show a transverse and a longitudinal calculated intensity distribution of a focus zone which is in the form of a surface of a cylinder and has a diameter of 40 p.m, as can be created in a material by means of a phase distribution of FIG. 2A;

FIG. 4 shows a flow diagram for illustrating a method for laser punching a microhole;

FIGS. 5A and 5B show photographs of microholes created by means of laser pulses;

FIG. 6 shows a photograph of a workpiece with three modifications;

FIGS. 7A to 7C show schematic representations for illustrating an areal phase distribution of a beam-shaping element for creating a focus zone, which is in the form of a surface of a cylinder and is subdivided azimuthally into sections, and an annular transverse intensity distribution having intensity zones restricted to azimuth angle regions;

FIGS. 8A and 8B show schematic representations for illustrating a phase distribution of a beam-shaping element for creating a focus zone with an elliptical cross-sectional area; and

FIGS. 8C and 8D show a transverse and a longitudinal calculated intensity distribution of a focus zone, which is subdivided azimuthally into sections and has an elliptical cross-sectional area.

### DETAILED DESCRIPTION

One aspect of the present disclosure involves introducing microholes having a diameter in the range of less than or equal to 100 μm into a thin glass and in particular an ultrathin glass (in general, a glass material of low thickness, e.g. with thicknesses in the range of several micrometers to several 100 micrometers or several millimeters).

In some embodiments, a diffractive optical beam-shaping element and a laser machining installation are used for introducing the microholes into the thin glass.

In one aspect of the present disclosure, a method for the selective laser-induced etching of a microhole into a workpiece includes the following steps:

creating a modification in the workpiece that extends from an entrance side to an exit side of the workpiece, the modification being created by means of a laser pulse which has an annular transverse intensity distribution extending in a propagation direction of the laser beam at least over a length which results in the modification being formed from the entrance side to the exit side of the workpiece, the modification delimiting a cylindrical body from a residual material surrounding the modification, and

introducing the workpiece with the modification into a wet-chemical etching bath for the purpose of structurally separating the cylindrical body from the residual material.

In a further aspect, a diffractive optical beam-shaping element for imposing a phase distribution on a transverse beam profile of a laser beam comprises

surface elements which adjoin one another and form an areal grating structure, in which each surface element is assigned a phase shift value and the phase shift values define a two-dimensional phase distribution, with

the two-dimensional phase distribution having a beam center position, which defines a radial direction in the areal grating structure,

the phase shift values each forming periodic grating functions, which have the same grating period, in the radial direction with respect to the beam center position, and

each of the periodic grating functions being assigned a radial grating phase with respect to the beam center position, which radial grating phase is formed by a phase contribution which increases continuously in an azimuthal circumferential manner or varies, in particular increases, decreases or alternates between one or more values, in azimuth angle sections.

In a further aspect, a laser machining installation for machining a workpiece by means of a laser beam by modifying a material of the workpiece in a focus zone of the laser beam, which focus zone has an elongate form in a propagation direction of the laser beam, comprises:

a laser beam source, which emits a laser beam, and

an optical system, which

has a diffractive optical beam-shaping element, or a combination of an axicon for imposing an axicon phase distribution and a spiral phase plate for imposing a vortex phase distribution or a combination of an axicon for imposing an axicon phase distribution and a lobe-beam phase plate for imposing a lobe-beam phase distribution, and

a machining head having a focusing lens.

The diffractive optical beam-shaping element is arranged in the beam path of the laser beam in order to impose a two-dimensional phase distribution on the laser beam, and the two-dimensional phase distribution is configured to bring about the formation of the elongate focus zone in the material by focusing the laser beam by means of the focusing lens, and, in order to create a modification, in particular by means of a laser pulse or a plurality of laser pulses, the focus zone has an annular transverse intensity distribution, in particular in the form of a circular ring or elliptical ring, that extends in a propagation direction of the laser beam at least over a length which results in the modification being formed from an entrance side of the material to an exit side of the material, the modification delimiting a cylindrical, in particular circular-cylindrical or elliptical-ring-cylindrical, body from a residual material surrounding the modification. The laser machining installation also comprises a wet-chemical etching bath for the purpose of structurally separating the cylindrical body from the residual material.

In some refinements of the method, the modification may extend in a hollow cylinder, which forms a circular ring or an elliptical ring in a cross section perpendicular to the propagation direction, and the cylindrical body may have the shape of a circular cylinder or an elliptical cylinder.

In some refinements, the annular transverse intensity distribution may have an intensity zone which runs continuously around the propagation direction of the laser beam and creates a modification zone, in the form of a surface of a cylinder, in the material of the workpiece as modification. It is optionally possible for the modification zone, in the form of a surface of a cylinder, to form a circular ring or an elliptical ring in a cross section perpendicular to the propagation direction.

In some refinements, the annular transverse intensity distribution may have multiple intensity zones, which are restricted to azimuth angle regions around the propagation direction of the laser beam and create a plurality of modification zones, running in the propagation direction of the laser beam and on a cylinder lateral surface around the propagation direction of the laser beam, in the material of the workpiece as modification. It is optionally possible for the plurality of modification zones to form a circular ring or an elliptical ring in a cross section perpendicular to the propagation direction.

In some refinements, the modification may constitute a structural change of the material of the workpiece that converts the material from a non-etchable state of the non-modified material into an etchable state of the modified material, the modification being characterized in particular by an increase in wet-chemical etchability compared to the non-modified material.

In some refinements of the method, a laser pulse or a plurality of laser pulses with identical transverse intensity distributions and longitudinal intensity distributions can be radiated in to create the modification in the form of a surface of a cylinder. The plurality of laser pulses may impinge on the workpiece in particular in the form of a burst of laser pulses at time intervals in the region of several nanoseconds or in the form of a sequence of separately timed laser pulses or bursts of laser pulses at time intervals in the region of up to several 100 microseconds. In the process, the plurality of laser pulses impinges in particular at the same location, in order to ensure an overlap of associated interaction regions.

In some refinements, the method may also comprise imposing a transverse phase distribution on the laser beam, which phase distribution results in the annular transverse intensity distribution after the laser beam has been focused. The annular transverse intensity distribution may, in particular in a circular ring shape, have a circle diameter which remains substantially unchanged along a propagation direction of the laser beam in the workpiece, or, in an elliptical ring shape, have a minimum diameter and a maximum diameter which remain substantially unchanged along a propagation direction of the laser beam in the workpiece.

In some refinements of the method, the phase distribution may be shaped by means of a diffractive optical beam-shaping element, or by a combination of an axicon for imposing an axicon phase distribution and a spiral phase plate for imposing a vortex phase distribution, or by a combination of an axicon for imposing an axicon phase distribution and a lobe-beam phase plate for imposing a lobe-beam phase distribution.

In some refinements, it is possible

for the workpiece to be a thin glass and in particular an ultrathin glass and/or

for the laser pulse to be an ultrashort pulse, in particular having pulse lengths of less than or equal to several picoseconds, in particular in the range of several to several hundred femtoseconds, and/or

for the annular transverse intensity distribution and therefore the microhole to have a circle diameter in the event of a circular transverse basic shape or a maximum diameter in the event of an elliptical transverse basic shape of less than or equal to 500 μm and/or

for the workpiece to have a thickness in the propagation direction of the incident laser beam of less than or equal to 2 mm, in particular in the range of from 5 μm to 2 mm or in the range of from 10 μm to 200 μm and/or

for the material of the workpiece to be largely transparent to the laser beam.

In some refinements, the method may also comprise effecting a relative movement between the workpiece and the laser beam in order to create an arrangement of microholes.

In some refinements of the diffractive optical beam-shaping element, the periodic grating functions may each comprise a component of a sawtooth grating phase profile, a gradient of a region of increase in each of the sawtooth grating phase profiles corresponding to a predetermined axicon angle assigned to the diffractive optical beam-shaping element. In this respect, the predetermined axicon angle may be in the range of from 0.5° to 40° for creating a real Bessel-beam intermediate focus by means of the laser beam downstream in beam terms from the diffractive optical beam-shaping element or in the range of from (−0.5)° to (−40)° for taking as a basis a virtual Bessel-beam intermediate focus upstream in beam terms from the diffractive optical beam-shaping element.

In some refinements of the diffractive optical beam-shaping element, the periodic grating functions may each comprise a component of a two-dimensional collimation phase distribution, in particular a two-dimensional focusing phase distribution, which is radially symmetrical with respect to the beam center position.

In some refinements, the laser machining installation may also comprise a workpiece holder, with optional provision of a relative positionability of the machining head and of a workpiece provided by the workpiece holder in the form of material to be machined.

In some refinements of the laser machining installation, the two-dimensional phase distribution may be configured such that the annular transverse intensity distribution has one intensity zone running continuously around the propagation direction of the laser beam or multiple intensity zones restricted to azimuth angle regions around the propagation direction of the laser beam. It is optionally possible for the modification to form a continuous or interrupted circular ring or a continuous or interrupted elliptical ring in a cross section perpendicular to the propagation direction of the laser beam.

According to aspects of the present invention, the use of a higher-order Bessel-beam-like beam prepares microhole contours for a wet-chemical etching method by means of a single laser pulse or multiple successive laser pulses which impinge at the same place with identical beam profiles, or alternatively by means of one or more bursts of laser pulses which impinge at the same location with identical beam profiles. In the process, the higher-order Bessel beam modifies the material on a cylinder lateral surface (in an azimuthally continuous manner or at least in azimuth angle sections), which surrounds an inner volume to be separated out. The material in this inner volume may be detached from the surrounding residual material by a subsequent etching process and forms a type of drill microcore. The drill core may be removed from the residual material (for example rinsed out by the etching medium), with the result that a microhole remains in the residual material. If the modification zones extend in azimuth angle sections, with the result that material bridges remain between the residual material and the drill core, a force which detaches the material bridges may additionally be required.

Embodiments of the present disclosure can permit small contours and holes to be separated out of transparent materials such as glass, transparent ceramics, sapphire, glass ceramic, etc. In this respect, the microholes can be formed with high productivity and small hole diameters (e.g. in the range of from 5μm to 500 p.m, particularly preferably 2μm to 200 p.m). Correspondingly, embodiments of the present disclosure are also referred to as optical laser punching.

Embodiments of the present disclosure use (three-dimensional) beam profiles, which have a diffraction-free (non-diffractive) form in the propagation direction. Since no substantial change in the intensity is present in the beam profile along the propagation direction, it is possible to create modifications in the material that are continuous in the propagation direction. Modifications of this type can extend continuously through a workpiece of small thickness and thus for example may be used for the formation of microholes in thin glasses and ultrathin glasses. A thin glass has material thicknesses in the range of from a few micrometers to several millimeters and in the lower thickness range is also referred to as ultrathin glass; for example, ultrathin glasses have thicknesses in the range of from 5 μm to several 100 μm, in particular in the range of from 10 μm to 200 μm, such as 30 μm, for example.

The present disclosure discloses embodiments which make it possible to at least partially improve aspects from the prior art. In particular, further features and their expedient aspects will emerge from the following description of embodiments with reference to the figures.

Aspects described in the present disclosure are based in part on the realization that, when modifying small contours by scanning a conventional Bessel-beam focus zone, as are described e.g. in the applicant's applications mentioned in the introduction, shielding effects owing to already modified material can arise. For example, it is possible for a modification in the depth of the material (at the end of the focus zone) to be influenced and in an extreme case to no longer be brought about. The use of zero-order Bessel beams of this type is in particular dependent on the aspect ratio and the material thickness of the material to be machined. A diameter of a geometry (hole contour) to be cut out by means of a scan trajectory can be subject to restrictions when using zero-order Bessel-beam-like beams of this type.

Now, embodiments of the present disclosure do not make use of scanning the laser radiation along a hole contour, but rather utilize a specially shaped beam profile. The beam profile has a cylinder-like form. That is to say that the laser parameters are set such that high intensities, i.e. above a threshold fluence/intensity of this material, are present along a cylinder wall geometry (in an azimuthally continuous manner or at least in azimuthal sections). The beam profile is also similar to a Bessel beam in such a way that energy enters the region of the cylinder wall laterally from the outside, with the result that both a first laser pulse, when the modification is being formed in the propagation direction, and further modifying by means of subsequent laser pulses at the same location are not influenced by the previously created modification.

In the method described below, in a first step, for example, a modification is inscribed into the workpiece, each modification being provided for the purpose of forming a microhole. In a second step, an etching operation is then performed. In the process, the etching medium acts along the modification into the material interior and detaches the interior of the microhole from the residual material. For example, the etching methods in the second step are performed over a period of several minutes or hours and in an etching medium such as KOH. The period of time and the etching medium can be matched to the material and to the modifications.

The inventors have discovered that the creation of a microhole with higher accuracy and better surface finish is made possible in particular also by radiating in a plurality of successive pulses (with the same beam profile at the same location). Moreover, it is possible to use lower pulse intensities, since the formation of a structure, in the form of a surface of a cylinder, of the modification can accumulate pulse by pulse.

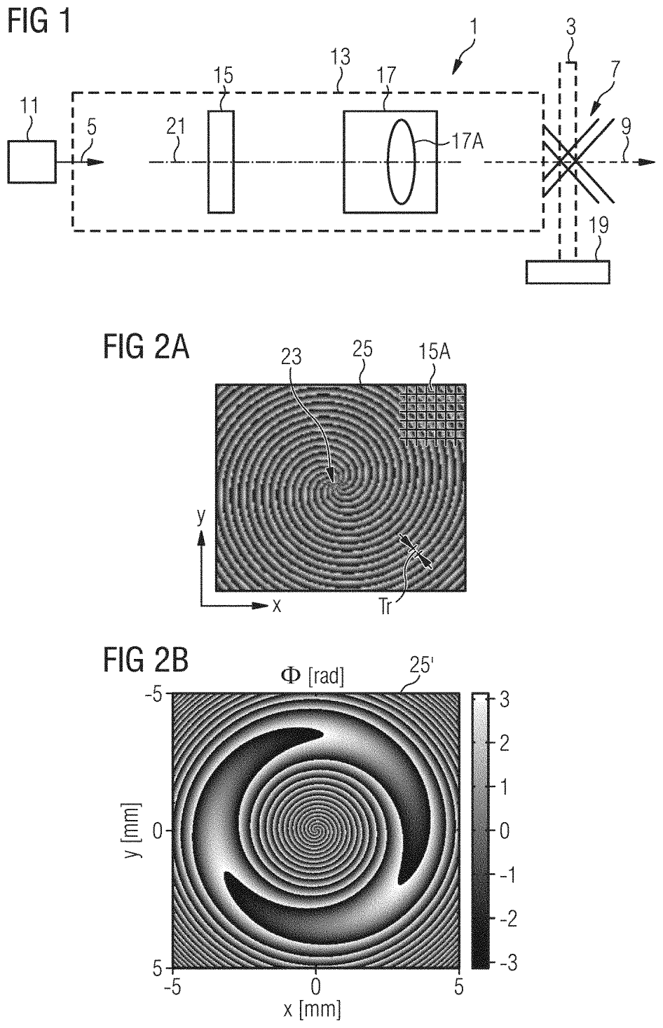

The laser punching of microholes will be described below by way of example with reference to FIGS. 1 to 8.

FIG. 1 shows a schematic illustration of a laser machining installation 1 for machining a material 3 by means of a laser beam 5. The machining brings about a modification of the material 3 in a focus zone 7. As is indicated in FIG. 1, the focus zone 7 may have a generally elongate form in a propagation direction 9 of the laser beam 5. For example, the focus zone 7 is a focus zone of a “modified” Bessel beam or of a “modified” inverse Bessel beam, as can be formed in a substantially transparent material. In this respect, the Bessel beams are modified in such a way that they have the beam profiles explained below, in particular intensity maxima that are present on a cylinder lateral surface.

The laser machining installation 1 comprises a laser beam source 11, which creates and emits the laser beam 5. The laser beam 5 is pulsed laser radiation, for example. Laser pulses have e.g. pulse energies resulting in pulse peak intensities, which bring about a volume absorption in the material 3 and therefore a formation of the modification in a desired geometry.

For the purpose of beam shaping and guidance, the laser machining installation 1 also comprises an optical system 13. The optical system 13 comprises a diffractive optical beam-shaping element 15 (or an optical system which imposes a corresponding phase distribution and is composed of multiple interacting optical elements) and a machining head 17 with a focusing lens 17A.

Further beam-guiding components of the optical system 13, such as mirrors, lenses, telescope arrangements, filters, and control modules for aligning the various components, for example, are not shown in FIG. 1.

Lastly, the laser machining installation 1 comprises a schematically indicated workpiece holder 19 for mounting a workpiece. In FIG. 1, the workpiece is the material 3 to be machined. It may be for example a thin glass sheet or a thin sheet largely transparent to the laser wavelength used that has a ceramic or crystalline configuration (for example of sapphire or silicon) as examples for thin-glass or ultrathin-glass material machining. For the machining of the material 3, a relative movement is effected between the optical system 13 and the material 3, with the result that the focus zone 7 can be radiated into the workpiece at various positions in order to form an arrangement of multiple modifications.

In general, the laser beam 5 is determined by beam parameters such as wavelength, spectral range, pulse shape over time, formation of pulse groups (bursts), beam diameter, transverse beam profile/input intensity profile, transverse input phase profile, input divergence and/or polarization.

Exemplary parameters of the laser beam 5 are:
Wavelength: e.g. 1030 nm
Pulse duration of less than or equal to several picoseconds (for example 3 ps), for example several hundred or several (tens of) femtoseconds
Pulse energies e.g. in the mJ range, between 20 μJ and 2 mJ (e.g. 1200 μJ), typically between 100 μJ and 1 mJ
Number of pulses in the burst: multiple pulses in one burst is possible, e.g. 1 to 4 pulses per burst with a time interval in the burst of several nanoseconds (e.g. approx. 17 ns)

Number of pulses per modification: one pulse or multiple pulses/bursts for one modification is possible, e.g. 2, 5 or 10 pulses with e.g. a time interval of 100 μs (10 kHz), 20 μs and 1 ms (1 kHz) between two successive pulses. By varying the time interval between the pulses and/or the number of pulses per modification, it is possible to influence the etchability of a material modification.

According to FIG. 1, the laser beam 5 is supplied to the optical system 13 for the purpose of beam shaping, i.e. converting one or more of the beam parameters. For the laser material machining, it will usually be the case that the laser beam 5 is approximately a collimated Gaussian beam with a transverse Gaussian intensity profile which is created by the laser beam source 11, for example an ultrashort-pulse high-power laser system. In terms of the laser radiation that can be used, reference is made by way of example to the laser systems and parameters described in the applicant's applications mentioned in the introduction.

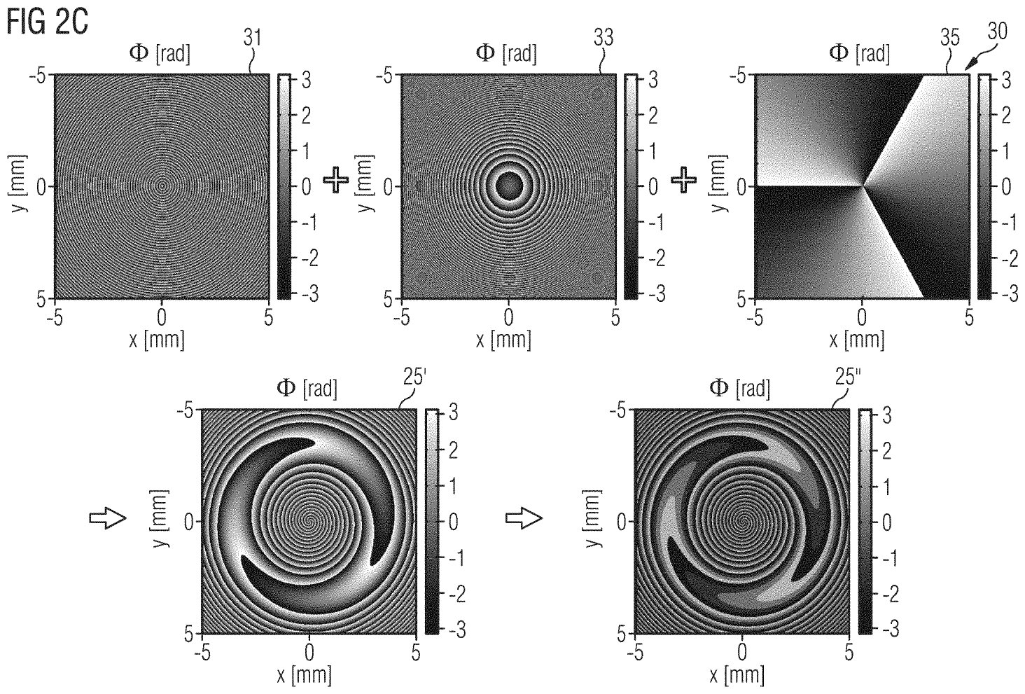

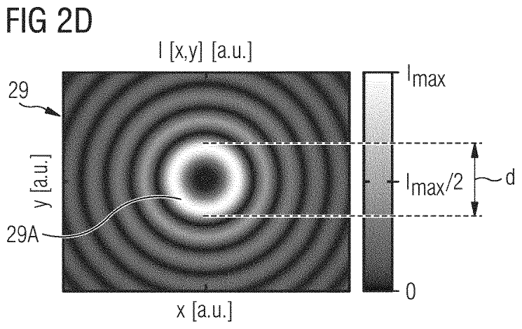

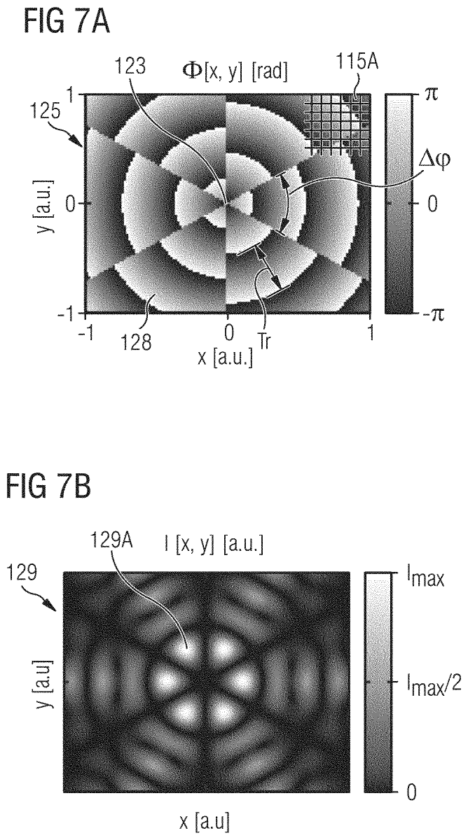

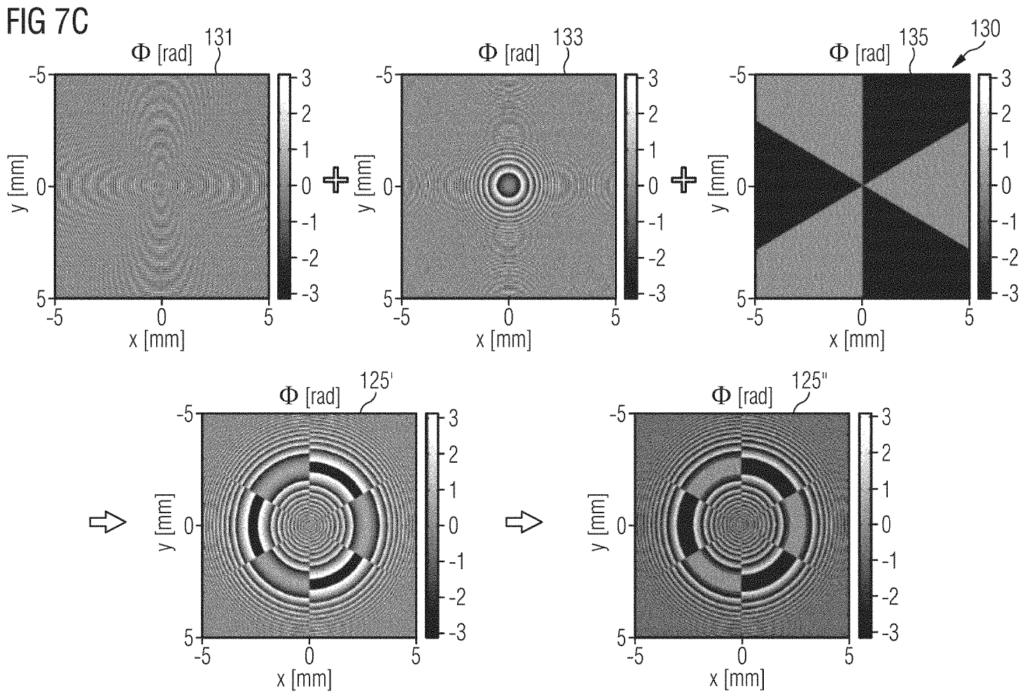

The optical system 13 is usually assigned an optical axis 21 which preferably runs through a point of symmetry of the beam-shaping element 15 (e.g. through a beam center position 23 of the diffractive optical beam-shaping element 15, see FIG. 2A, or through a beam center position 123 of the diffractive optical beam-shaping element 115, see FIG. 7A). In the case of a rotationally symmetrical laser beam 5, a beam center of a transverse beam profile of the laser beam 5 along the optical axis 21 of the optical system 13 may be incident on the beam center position 23.

The beam-shaping element 15 is e.g. a spatial light modulator (SLM). It may be configured for example as a permanently inscribed diffractive optical element. It is also possible for the beam-shaping element 15 to be implemented electronically by setting a programmable diffractive optical element in a time-dependent manner. Beam-shaping elements of this type are usually digitalized beam-shaping elements which are designed to impose a phase profile (of a two-dimensional phase distribution) on a transverse beam profile of a laser beam. In this respect, the digitalization may relate to the use of discrete values for the phase shift and/or the transverse grating structure. As an alternative, the phase distribution may be created by means of a combination of an axicon optical unit and a phase plate (which is in the form e.g. of a permanently inscribed diffractive optical element) (see e.g. FIG. 2C).

In general, it is possible for a settable diffractive optical beam-shaping element to allow very fine phase changes (very small differences in the phase shift values in adjacent surface elements) along with a laterally coarser resolution (larger surface elements/regions of a phase shift value) by contrast to a lithographically produced, permanently inscribed diffractive optical element, for example. Given a settable beam-shaping element (e.g. an SLM), the phase modulation can be achieved by locally changing the refractive index. The phase modulation in a permanently inscribed (static) beam-shaping element can be achieved by locally changing the distance traveled through an e.g. etched height profile in quartz glass, for example. A permanently inscribed diffractive optical element may comprise e.g. plane-parallel steps, a material thickness in the region of a step (a surface element) determining the extent of a phase shift (i.e. the phase shift value). The lithographic production of the plane-parallel steps can make a high lateral resolution (smaller surface elements/regions of a phase shift value) possible. In general, a phase shift value specifies a phase assigned to a point or a surface that experiences laser radiation upon interaction with an optical system for imposing a phase, for example when passing through a surface element of a diffractive optical beam-shaping element.

Depending on the configuration of a beam-shaping element, it can be used in transmission or in reflection in order to impose a phase profile on a laser beam. It is generally possible to use the beam-shaping elements proposed in the present disclosure for example in the applicant's optical setups described in the applications mentioned in the introduction. The underlying features will be explained by way of example in conjunction with FIGS. 2 to 8.

Structural and areal beam-shaping elements that impose a phase are also referred to as phase masks, the mask relating to the phase of the two-dimensional phase distribution.

The two-dimensional phase distribution according to embodiments of the present disclosure is designed in particular for the creation (after focusing by means of the focusing lens 17A) of an elongate focus zone. A focus zone corresponds to a three-dimensional intensity distribution which determines the spatial extent of the interaction and therefore the extent of the modification in the material 3 to be machined. A fluence/intensity above the threshold fluence/intensity of the material 3 that is relevant for the machining/modification is thus created as elongate focus zone in a region in this material that is elongate in the propagation direction 9.

Reference is usually made to an elongate focus zone when the three-dimensional intensity distribution in terms of a target threshold intensity is characterized by an aspect ratio (extent in the propagation direction in comparison with the lateral extent) of at least 10:1 and more, for example 20:1 and more or 30:1 and more, e.g. even of greater than 1000:1. An elongate focus zone of this type can result in a modification of the material with a similar aspect ratio. In general, in the case of aspect ratios of this type, a maximum change in the lateral extent of the (effective) intensity distribution over the focus zone may be in the range of 50% and less, for example 20% and less, for example in the range of 10% and less. In the event of the use according to aspects of the present invention of focus zones in the form of a cylinder wall, an aspect ratio may relate to a radial section, in particular given large diameters.

In particular with Bessel-beam-like beam profiles, it is possible for the energy to be introduced laterally into the elongate focus zone (i.e. at an angle to the propagation direction 9) for the volume absorption substantially over the entire length of a modification to be brought about. In this context, a Gaussian beam cannot generate a comparable elongate focus, since the energy is supplied substantially longitudinally and not laterally.

With a view to the volume absorption, the transparency of a material which is “largely transparent” to the laser beam 5 relates to a linear absorption. For light below the threshold fluence/intensity, a material which is largely transparent to the laser beam 5 for example can absorb e.g. less than 20% or even less than 10% of the incident light on a length of a modification to be brought about.

Returning to the beam shaping, FIG. 2A schematically shows a phase distribution 25 of a permanently inscribed diffractive optical beam-shaping element 15. FIG. 2B shows a phase distribution 25′ which additionally comprises a phase component for the integration of a lens into the beam-shaping element. If a “lens” is concomitantly inscribed in the beam-shaping element, a focusing action can be produced. In this case, it is possible to obtain the Fourier transform of the applied optical field in the form of an annular distribution, e.g. with a constant or modulated azimuthal dependence.

FIGS. 2A to 2C illustrate the underlying phase shift values (phase in rad) from −π to +π in grayscale. As is explained below, the phase distribution 25 and in general the phase imposition performed for shaping a “vortex” Bessel beam have an azimuthal phase dependence.

The beam-shaping element 15 may—in the same way as an axicon that is modified (in particular supplemented by a phase plate)—be arranged in the beam path of the laser beam 5 for the purpose of imposing a phase in accordance with the phase distribution 25 on the transverse beam profile of the laser beam 5.

FIG. 2A illustrates parameters of the phase distribution 25 and parameters of an areal grating structure, the areal grating structure implementing the phase distribution 25.

The areal grating structure can be set up using surface elements 15A that adjoin one another. The surface elements 15A refer to spatial structural units of the grating structure which make it possible to bring about a preset phase shift for the impinging laser radiation in accordance with a phase shift value assigned to the surface element. A surface element 15A correspondingly acts on a two-dimensional sector of the transverse beam profile of the laser beam 5. Surface elements correspond to the digitalization aspect previously mentioned. Exemplary surface elements 15A are indicated in FIG. 2A in the upper right-hand corner of the phase distribution 25, the size ratio between the exemplary rectangular surface elements and the phase dependence depending on the production of the beam-shaping element.

The surface elements 15A form a vortex-like phase development over the areal grating structure.

Also depicted in the phase distribution 25 of FIG. 2A is the already mentioned beam center position 23, to which the center of the incident laser beam 5 is adjusted. The beam center position 23 defines a radial direction in the areal grating structure (in FIG. 2A in the plane of the drawing beginning at the beam center position 23). The phase profiles form periodic grating functions in the radial direction, the grating functions having the same grating period Tr in the radial direction. In this respect, there is a constant grating period in the radial direction. For example, the phase of the radial phase profiles may change by 3×2π (in general, an e.g. integral multiple of π) over an azimuth angle of 2π. For example, the radial phase profile may change by 20×2π and more. Radial grating phases, which are assigned e.g. as original phase values to the radial grating functions at the beam center position 23, change accordingly.

In some embodiments, the periodic grating functions each comprise a component of a sawtooth grating phase profile. In the case of a sawtooth grating profile, the phase shift values in the radial direction have repeating increasing/decreasing regions, which are restricted by instances of phase resetting (e.g. jumps in the phase shift value), it being possible for the increases/decreases in the phase shift values to run in particular linearly (linear profiles make it possible in particular to form a diffraction-free beam). Further components in the phase profile (e.g. the mentioned case of a multiplexed lens discussed in conjunction with FIG. 2C) are possible and may overlay the embodiments of the present disclosure.

As an example for integration of a further phase component, a phase component of a far field optical system, which is arranged downstream in beam terms from the beam-shaping element 15 in the optical system 13, may be included in the phase distribution. It is therefore possible for a collimation phase distribution, which is radially symmetrical, for example, to be integrated into the two-dimensional phase distribution. (In this respect, also see the applicant's applications mentioned in the introduction.)

A gradient of a region of increase in the radial sawtooth grating phase profiles corresponds to a predetermined axicon angle. The latter is assigned to the diffractive optical beam-shaping element 15 and determines the formation of the Bessel beam. The predetermined axicon angle (“real axicon”) may be e.g. in the range of from 0.5° to 40°, particularly preferably 1° to 5°, for creation of a real Bessel-beam intermediate focus by means of the laser beam downstream in beam terms from the diffractive optical beam-shaping element. For taking as a basis a virtual Bessel-beam intermediate focus upstream in beam terms from the diffractive optical beam-shaping element 15, the predetermined axicon angle (“inverse axicon”) may be e.g. in the range of from −0.5° to −40°, particularly preferably −1° to −5°.

In summary, for the creation of the beam profile that can be used for the optical punching, it is possible to use an optical concept which creates higher-order Bessel-beam-like beams.

By contrast to a “punctiform” transverse intensity distribution in the machining region of a conventional Bessel-beam focus zone (zero-order Bessel beam), use is made of an “annular” transverse intensity distribution by imposing a two-dimensionally transverse phase distribution necessary for this on the incident laser beam, for example by means of a permanently inscribed diffractive optical element or a settable spatial light modulator or a combination of axicon and phase plate for vortex formation (see FIG. 2A, for example). In terms of a combination of axicon and phase plate for formation of a lobe beam, see the explanations relating to FIGS. 7A to 7C.

To this end, the diffractive optical element has a phase distribution which multiplexes (combines) the radially symmetrical sawtooth grating mentioned with a vortex phase modulation, the vortex phase modulation having a linear azimuthal phase increase (of 0 to I×2π, with I being the charge). The charge makes it possible to set the size of the transverse output ring created, inter alia. On account of the underlying Bessel-beam characteristic, the diameter of the transverse output ring substantially does not change along the propagation direction (Z axis in the figures).

As is indicated in FIG. 2C, a transverse and longitudinal beam profile of this type can also be implemented refractively using an axicon (an axicon phase distribution 31) and a spiral phase plate 30 (with a vortex phase distribution 35).

FIG. 2C can also generally explain the structure of the phase distribution 25′ (and similarly the phase distribution 25 without a lens phase component). By way of example, a phase distribution 31 of an inverse axicon (for creating an inverse Bessel-beam profile) is overlaid in each surface element with a lens phase component of a phase distribution 33 and a vortex phase component of the vortex phase distribution 35. If such a phase distribution is implemented by way of a 4-phase model on the surface elements 15A, the result is e.g. the phase distribution 25″.

In a transverse section (i.e. a section running perpendicularly to the propagation direction of the laser radiation in the focus zone 7), FIG. 2D shows an exemplary annular transverse intensity distribution 29 (I(x, y)), as can be created using a beam-shaping element having the areal phase distribution 25 for imposition on an ultrashort-phase laser beam. The phase distribution 25 has been imposed on the laser beam for example using a permanently inscribed diffractive optical element or a settable spatial light modulator or a combination of axicon and spiral phase plate 30. The resulting intensity distribution 29 forms a continuous ring and has an intensity zone 29A which runs continuously around the propagation direction Z of the laser beam 5.

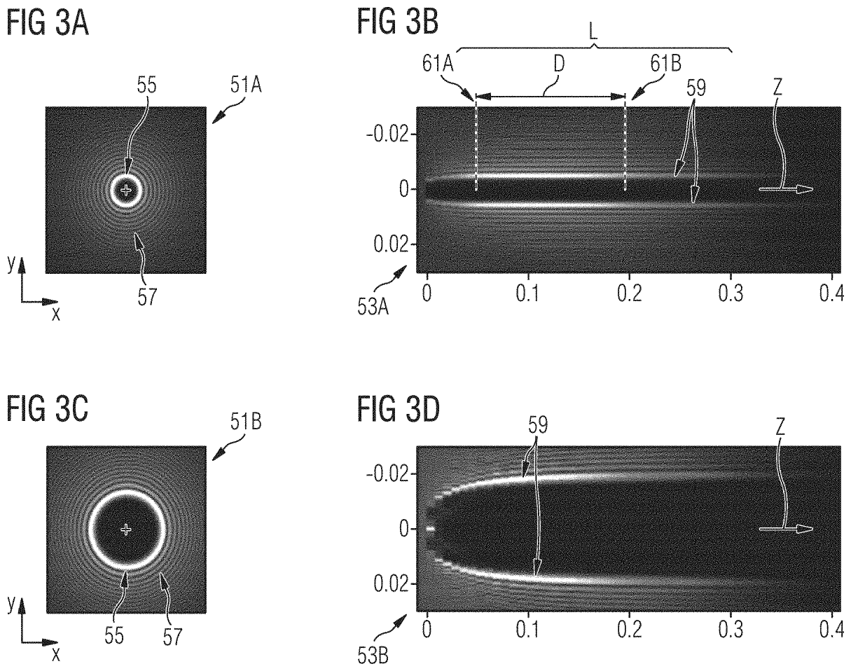

In summary, it is possible to create a cylindrical (Bessel-vortex) beam profile by imposing a phase distribution 25 produced by overlaying an “axicon” phase with an azimuthal phase component. In the case of a cylindrically symmetrical (Bessel-vortex) beam profile, the result is an annular transverse beam profile (see FIG. 3A and FIG. 3C), and therefore a (closed) modification is produced in the material along a cylinder wall surface.

The phase distribution 25 may also (similarly to the exemplary phase distribution 125 explained in conjunction with FIGS. 7A to 7C) be designed such that it creates a beam profile that is substantially diffraction-free in the propagation direction. A diffraction-free formation can be achieved when the phase distribution 25 (phase distribution 125) has the same grating period in all directions. In this respect, the condition of the “same grating period” relates to the phase components for forming the focus zone. As already mentioned, further phase components may be integrated into the beam-shaping element, e.g. for integration of an optical lens. These phase components have dedicated grating structures, as is presupposed for example for a focusing (rotationally symmetrical) phase imposition.

FIGS. 3A to 3D show two intensity distributions by way of example, as can be produced after the phase-imposed beam has been focused. FIGS. 3A and 3C show intensity rings in lateral sections (transverse X-Y beam profiles 51A and 51B), which are formed transversely to the propagation direction Z and are part of focus zones having cylinder diameters of approx. 10 μm and approx. 40 μm, respectively. FIGS. 3B and 3D show corresponding sections along the propagation direction (longitudinal beam profiles 53A and 53B).

The formation of a circularly shaped main maximum 55 and multiple secondary maxima 57 lying radially further outward can be seen in the transverse beam profiles 51A and 51B. The secondary maxima 57 lie e.g. below a relevant threshold fluence/intensity of a material to be machined, with the result that no material modification is brought about there. The material structure is therefore modified only in the region of the innermost maximum 55. The modification extends in a hollow cylinder which forms a circular ring in a cross section perpendicular to the propagation direction.

In the longitudinal beam profiles 53A and 53B, it can also be seen how the main maxima 55 and the secondary maxima 57 form elongate focus zones 59 having the form of a surface of a cylinder and exhibiting no diffraction effects along the propagation direction.

In order to illustrate the machining of a thin workpiece, what is schematically indicated in FIG. 3B is an entrance side 61A for the laser beam and exit side 61B for the laser beam, which sides are for example the top side and the bottom side of a thin glass plate through which a hole is to be made. A thickness D of the glass plate is smaller than an assumed length L of the focus zone in the propagation direction Z.

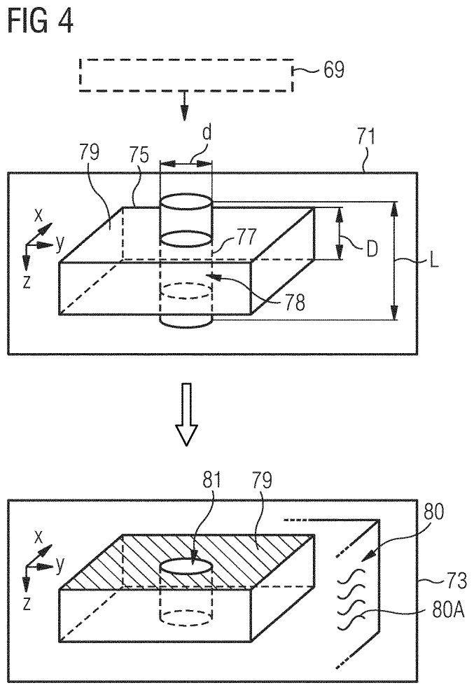

With reference to FIG. 4, it is possible to generally reproduce on a smaller scale (e.g. by means of a telescope arrangement) a modified (real or virtual) Bessel-beam focus zone, which is assigned to the diffractive optical system and is similar to a surface of a cylinder, in a workpiece 75. To that end, in a first step 69 a corresponding two-dimensional phase may be imposed transversely on a laser beam. Exemplary transparent materials include quartz glass, borosilicate glass, aluminosilicate glass (alkali metal aluminosilicate glass), boroaluminosilicate glass (alkaline earth metal boroaluminosilicate glass) and sapphire.

Given sufficient intensity, a cylinder lateral surface 77 in the workpiece 75 is modified. The cylinder lateral surface 77 surrounds a body 78 that has a cylinder-like shape and separates it from a residual material 79. This corresponds to a modification step (step 71 in FIG. 4), in which the material structure is selectively changed in the cylinder lateral surface 77 for improved etchability.

In a subsequent etching method step (step 73 in FIG. 4), by detaching the material modified in the form of the cylinder lateral surface, a body that has a cylinder-like shape is detached from the residual material 79. Exemplary parameters of the etching operation are an etching medium such as 28% by weight KOH and an etching temperature of e.g. 80° C. The etching method step is usually performed in an etching bath 80 of an etch 80A and may optionally be assisted by radiation of ultrasound into the etching bath.

If the detached body is removed or drops out of the residual material 79, there remains in the residual material 79 a microhole 81 that corresponds to a cylindrical bore with an extremely small diameter. If the intensity zones explained in conjunction with FIG. 7C do not bring about a body which is completely detached by wet-chemical etching, it is possible for said body to be removed e.g. by mechanically detaching the connecting lines.

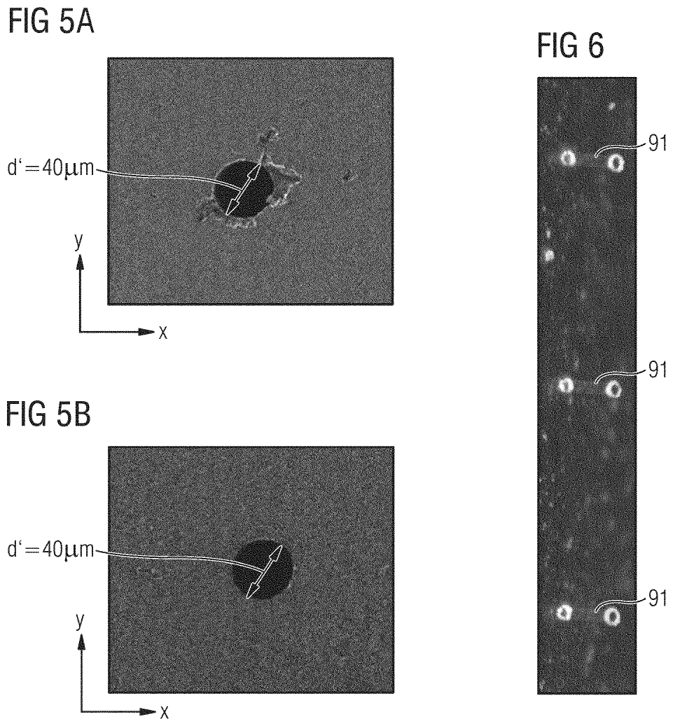

FIGS. 5A and 5B show micrographs of holes with hole diameters d′ of approx. 40 μm. Exemplary parameters of a microhole/a microhole structure are hole diameters in the region of 100 μm, in particular smaller than 100 μm, such as 20 μm or 25 μm, for example, and a distance from the next-adjacent microhole in the order of magnitude of e.g. one hole diameter or more, such as at least twice to three times the hole diameter (minimum distances of from e.g. 10 μm to 60 μm, for example 20 μm or 40 μm).

With reference to FIGS. 5A and 5B, according to embodiments of the present disclosure, it is possible to vary a number of the pulses per burst (single pulses, double pulses, 3, 4 or more pulses per burst) and/or a number of pulses per modification, and also the time interval between them.

FIG. 6 shows a micrograph of an arrangement of three spaced-apart modifications 91 in a workpiece, which were made visible by an establishing etching process.

Returning to beam shaping by means of the beam-shaping element 15 of FIG. 1, FIGS. 7A to 7C show schematic illustrations of phase masks for illustrating areal phase distributions, as may be present in alternative beam-shaping elements. As is the case in FIGS. 2A to 2C, in FIGS. 7A and 7C the phase shift values 101 (x, y) are illustrated in grayscale values in [rad] from “−π” to “+π”. In this case, the resulting beam-shaping elements brought about the creation of a focus zone which is subdivided into azimuthal sections and consequently has the form of a surface of a cylinder in certain sections. In other words, the focus zone has an annular transverse intensity distribution, in which zones of increased intensity are only present in some azimuth angle regions.

FIG. 7A schematically shows a phase distribution 125 (phase shift values Φ(x, y)), as can be implemented for example by means of the permanently inscribed diffractive optical beam-shaping element 15 (see FIG. 1). The beam-shaping element 15 is arranged in the beam path of the laser beam 5 in order to impose a phase distribution (i.e. of phase shift values in accordance with the phase distribution 125) on the transverse beam profile of the laser beam 5. Depicted in the phase distribution 125 of FIG. 7A is a beam center position 123, to which the center of the incident laser beam 5 is preferably adjusted.

The phase distribution 125 may be created by overlaying a phase distribution of an (inverse) axicon and a phase distribution with azimuthal jumps in the phase (alternating phase shift values of “0” and “−π”). (In this respect, also see the procedure explained in conjunction with FIG. 7C, but without a lens phase distribution.) Six phase jumps in the azimuthal direction can be seen in FIG. 7A. That is to say, specific phase profiles were formed in six azimuth angle regions 128 over a Δφ of 60° in each case in the beam-shaping element 15.

In FIG. 7A, the areal radial grating structure is formed by surface elements 115A that adjoin one another (see the description in relation to FIG. 2A). The size ratio between the surface elements 115A, shown as rectangular by way of example, and the phase dependence (grating period Tr in the radial direction) is primarily a result of the technical implementation of the beam-shaping element.

Respectively oppositely situated azimuth angle regions 128 correspond in terms of their radial phase profiles. In this respect, the radial direction is defined through the beam center position 123 in the center of the areal grating structure. In the radial direction, the radial phase profiles form periodic grating functions having a sawtooth grating phase profile, grating functions with the same grating period Tr in the radial direction being present in the azimuth angle regions 128. However, the radial grating phases of said grating functions may differ. Therefore, in FIG. 7A, the radial grating phase of adjacent azimuth angle regions 128 alternates between “0” and “−π” (projected onto the beam center position 123). The six azimuth angle regions 128 (with pi phase differences) in FIG. 7A extend over angle segments (Δφ=60°) of the same size. The corresponding result is a sixfold rotational symmetry of the phase distribution 125 around the beam center position 123 (and therefore also of the intensity distribution around the beam axis—see in this respect FIG. 7B).

The phase distribution 125 may be used to create what is referred to as a lobe beam having six primary intensity zones distributed in an azimuthally uniform manner. These radially innermost intensity zones have an annular arrangement.

When the focus zone is being reproduced in a workpiece, the intensity zones extend along the beam direction Z and thus form an elongate focus zone. The intensity zones define the profile of a cylinder lateral surface. For the creation of a through-microhole, the parameters of the focus zone are selected in such a way that the elongate focus zone (preferably with a virtually constant diameter) extends between the two surfaces of the workpiece, for example a thin glass or an ultrathin glass.

FIG. 7B shows a transverse section (perpendicular to the propagation direction of the laser radiation in the focus zone 7) of an exemplary annular transverse intensity distribution 129 (I(x, y)). The intensity distribution 129 may be created by means of a beam-shaping element, which has the areal phase distribution 125 for imposition on an ultrashort-pulse laser beam, for example using a permanently inscribed diffractive optical element or a settable spatial light modulator or a combination of axicon and lobe-beam phase plate. The intensity distribution 129 has azimuthally restricted intensity zones 129A in six azimuth angle regions (60° in each case) in the X-Y plane. This makes it possible to axially locally increase the energy of a laser pulse. For example, the intensities in the intensity zones 129A may be twice as high as they were given the same laser parameters in the intensity ring 29A in FIG. 2D.

By contrast to an “annular” transverse intensity distribution with an intensity zone running continuously around the propagation direction Z of the laser beam 5 (see e.g. FIG. 2D), the annular transverse intensity distribution 129 has multiple (in this instance, by way of example, six) intensity zones 129A restricted to azimuth angle regions around the propagation direction Z of the laser beam 5.

Focus zones of this type can also be used for the optical punching of microholes. When the intensity zones very closely approximate one another in the case of an azimuthally segmented annular transverse beam profile, a virtually closed modification along a cylinder wall surface can be produced in the material of the workpiece 75. Said modification can result in a continuous material machining region along a cylinder lateral surface in the wet etching operation. In the case of azimuthally more remote intensity zones, it is possible to create a plurality of modification zones in the material of the workpiece 75 which run along the propagation direction of the laser beam in the focus zone and on a cylinder lateral surface around the propagation direction of the laser beam. In this context, the distance between the modification zones may be such that the wet etching operation makes it possible for the modification zones to no longer be connected such that they form a completely connected material machining region. Thus, connecting lines may remain between the inside and the outside of the cylinder lateral surface defined by the intensity zones 129A.

In a similar way to FIG. 2C, FIG. 7C illustrates how a lens component acts on a phase distribution such as the phase distribution 125 of FIG. 7A. A phase distribution 131 of an inverse axicon (radially symmetrical sawtooth grating as for creating an (inverse) Bessel-beam profile) in the form of an output phase profile is shown on the left-hand side in the top row of FIG. 7C. By way of example, the two-dimensional phase distribution shown may extend over a dimension of 5 mm×5 mm. The axicon phase distribution 131 is combined (multiplexed) with a lens phase component, for example with a collimating phase component (phase distribution 133, in the middle in the top row of FIG. 7C) of a far field optical unit, which could be arranged in the optical system 13 downstream in beam terms from the beam-shaping element 15.

For the formation of the azimuthal intensity regions, a further two-dimensional phase component is included which has constant phase shift values in multiple azimuth angle regions (lobe-beam phase distribution 135, on the right-hand side in the top row of FIG. 7C). The number of the intensity zones of the transverse and azimuthally modulated output ring created can be set by way of the number of azimuth angle regions.

As is indicated in FIG. 7C, a transverse and longitudinal beam profile of this type can also be implemented refractively using an axicon (an axicon phase distribution) and a lobe-beam phase plate 130 (with a lobe-beam phase distribution 135).

On account of the underlying Bessel-beam characteristic (radial sawtooth phase profile), the diameter of the transverse and azimuthally modulated output ring substantially does not change along the propagation direction (Z axis in the figures).

The combination of the three phase distributions 131, 133, 135 results in a phase distribution 125′ with continuous phase shift values (a multiplicity of phase shift values) of between “−π” and “+π”.

The phase distribution 125′ may be implemented by way of a 4-phase model (e.g. using the four phase shift values “−π”, “−π/2”, “0” and “+π/2”) on the surface elements 115A, resulting in a phase distribution 125″.

For example, the phase distribution 125″ of FIG. 7C may be implemented in a diffractive optical element. As an alternative, the phase distribution 125 or the phase distribution 125″ may be achieved by a combination of an axicon for imposing an (inverse) axicon phase distribution and a lobe-beam phase plate 130 for imposing a lobe-beam phase distribution (and optionally extended by a collimation phase distribution). In this respect, a lobe-beam phase plate 130 is understood to mean a phase mask which is subdivided azimuthally into angle segments and which has constant, angle-segment-specific phase shift contributions.

The intensity distributions shown in FIGS. 3A, 3C and 7B have in the focus zone a rotational symmetry with respect to the beam axis. The intensity distributions may have rotationally symmetrical beam cross sections (rotational symmetry in the narrower sense or with a predetermined order of symmetry). The rotational symmetry results in a modification which can be formed continuously along a lateral surface of a circular cylinder, or in modifications arranged on a lateral surface of a circular cylinder. That is to say, the modification zone(s) optionally form a circular ring in a cross section perpendicular to the propagation direction Z.

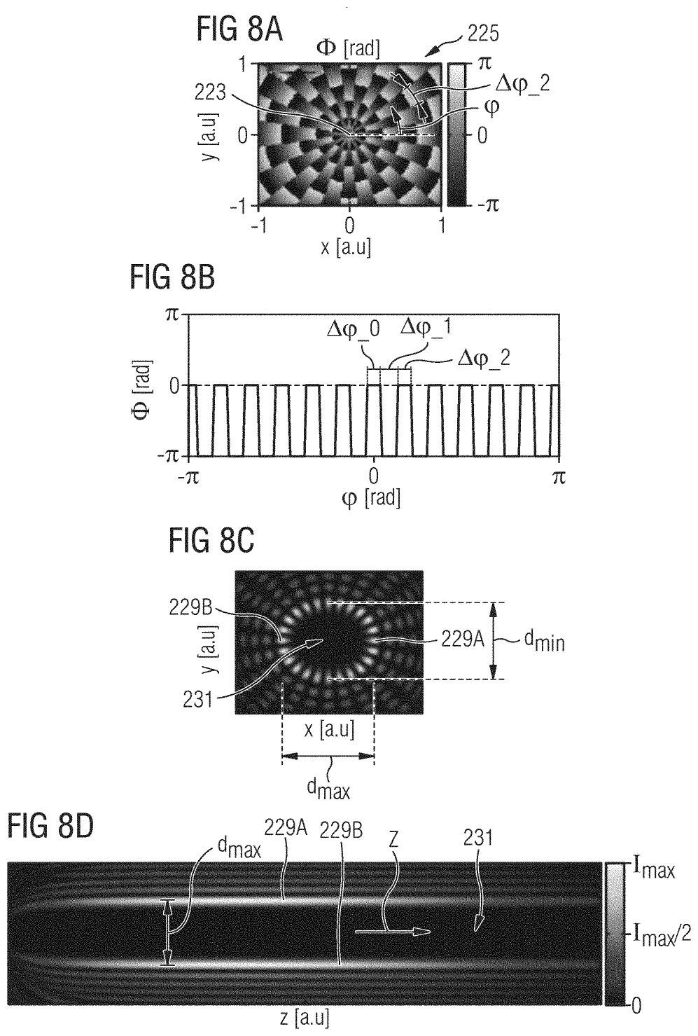

FIGS. 8A to 8D illustrate the extension to a focus zone having a cross-sectional area in the form of an elliptical ring. These figures show by way of example the case in which intensity maxima run in azimuthal sections on a lateral surface of an elliptical cylinder in the propagation direction Z.

FIG. 8A schematically shows a phase distribution 225 with areally distributed phase shift values Φ(x, y). The phase distribution 225 may be implemented for example using a permanently inscribed diffractive optical beam-shaping element (beam-shaping element 15 in FIG. 1). The beam-shaping element is arranged in the beam path of the laser beam in order to impose its phase distribution (i.e. the phase shift values in accordance with the phase distribution 225) on the transverse beam profile of the laser beam. Depicted in the phase distribution 225 of FIG. 8A is a beam center position 223, to which the center of an incident laser beam is preferably adjusted. Also depicted in FIG. 8A is the azimuth angle φ.

The phase distribution 225 may be created, like the phase distribution 125 of FIG. 7A, by overlaying a phase distribution of an (inverse) axicon and a phase distribution with azimuthal jumps in the phase (alternating phase shift values of “0” and “−π”).

FIG. 8B shows an azimuthal phase profile Φ(φ) for the phase distribution 225 at a radial position at which the phase jumps take place between “−π” and “0”.

24 phase jumps in the azimuthal direction can be seen in FIGS. 8A and 8B. By way of example, FIG. 8B characterizes three azimuth angle regions Δφ_0, Δφ_1, Δφ_2. It can be seen that the azimuth angle regions of the phase distribution 225 have different sizes, a point symmetry being given with respect to the beam center position 223.

It can also be seen in FIG. 8A that the grating period in the radial direction is identical in all of the azimuth angle regions, and that the phase 41) varies continuously (linearly) from “+π” to “−π” in the radial direction and correspondingly forms a sawtooth grating phase profile.

As is shown in FIG. 8C, the phase distribution 225 may be used to create a lobe-beam-like beam having 24 intensity zones 229A, 229B. The 24 intensity zones 229A, 229B are arranged distributed in an ellipse shape in relation to the propagation direction Z in an X-Y cross section. FIG. 8C depicts a maximum diameter dmax in the X direction and a minimum diameter dmin in the Y direction of the elliptical shape. The minimum diameter dmin and the maximum diameter dmax remain substantially unchanged along the propagation direction Z of the laser beam. In this case of an elliptical transverse basic shape, the maximum diameter dmax is preferably less than or equal to 500 μm.

Correspondingly, FIG. 8D shows intensity profiles in a Z-X section through the focus zone, specifically through the intensity zones 229A, 229B of FIG. 8C. The intensity profiles extend in the Z direction in an elongate manner, for example with a high aspect ratio of e.g. 10:1 and more, for example 20:1 and more or 30:1 and more, e.g. even of greater than 1000:1.

The 24 intensity zones 229A, 229B delimit a volume 231 in the form of an elliptical cylinder in the interior of the focus zone, which volume extends along the beam propagation direction Z. If a high-intensity laser beam shaped in this way is radiated into a workpiece, it is possible to create a modification of the material of the workpiece that extends from one side of the workpiece to the other.

The modification may comprise for example a plurality of modification zones, which originate from the intensity zones 229A, 229B. In the workpiece, the modification delimits a cylindrical body, which has the shape of an elliptical cylinder. If the workpiece with a modification of this type is introduced into a wet-chemical etching bath, the body can be separated structurally from the residual material. If the detached body is removed from the workpiece, the result is a through-hole through the workpiece that has an elliptical cross section.

It should be noted that it is also possible to create phase masks which result in a continuous intensity maximum in the form of an elliptical cylinder lateral surface, for example using a correspondingly adapted vortex phase distribution (see FIG. 2C).

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for selective laser-induced etching of a microhole into a workpiece, the method comprising the following steps:
creating a modification in the workpiece that extends from an entrance side to an exit side of the workpiece, the modification being created by a laser pulse that has an annular transverse intensity distribution extending in a propagation direction of the laser beam at least over a length which results in the modification being formed from the entrance side to the exit side of the workpiece, the modification delimiting a cylindrical body from a residual material surrounding the modification, and
introducing the workpiece with the modification into a wet-chemical etching bath for structurally separating the cylindrical body from the residual material.

2. The method as claimed in claim 1, wherein the modification extends along a hollow cylinder, which forms a circular ring or an elliptical ring in a cross section perpendicular to the propagation direction, and the cylindrical body has the shape of a circular cylinder or an elliptical cylinder.

3. The method as claimed in claim 1, wherein the annular transverse intensity distribution has an intensity zone which runs continuously around the propagation direction of the laser beam and creates a modification zone in the form of a surface of a cylinder, in the workpiece as modification.

4. The method as claimed in claim 3, wherein the modification zone forms a circular ring or an elliptical ring in a cross section perpendicular to the propagation direction

5. The method as claimed in claim 1, wherein the annular transverse intensity distribution has multiple intensity zones, which are restricted to azimuth angle regions around the propagation direction of the laser beam and creates a plurality of modification zones, running in the propagation direction of the laser beam and on a cylinder lateral surface around the propagation direction of the laser beam, in the workpiece as modification.

6. The method as claimed in claim 5, wherein the plurality of modification zones forms a circular ring or an elliptical ring in a cross section perpendicular to the propagation direction.

7. The method as claimed in claim 1, wherein the modification includes a structural change of a material of the workpiece that converts the material from a non-etchable state into an etchable state., the modification is characterized by an increase in wet-chemical etchability compared to before the modification.

8. The method as claimed in claim 1, wherein with a laser pulse or a plurality of laser pulses having identical transverse intensity distributions and longitudinal intensity distributions being radiated to create the modification in the form of a surface of a cylinder, the laser pulse(s) impinge on the workpiece in a form of a burst of laser pulses at time intervals of several nanoseconds. or in a form of a sequence of separately timed laser pulses or bursts of laser pulses at time intervals of up to several 100 microseconds, and wherein the plurality of laser pulses impinge at a same location in order to ensure an overlap of interaction regions.

9. The method as claimed in claim 1, further comprising:
imposing a transverse phase distribution on the laser beam, wherein the phase distribution results in the annular transverse intensity distribution after the laser beam has been focused.

10. The method as claimed in claim 9, wherein the annular transverse intensity distribution has (i) a circular ring shape with a diameter that remains substantially unchanged along a propagation direction of the laser beam in the workpiece, or (ii) an elliptical ring shape with a minimum diameter and a maximum diameter that remain substantially unchanged along the propagation direction of the laser beam in the workpiece.

11. The method as claimed in claim 9, wherein the phase distribution is shaped by (i) a diffractive optical beam-shaping element, or (ii) by a combination of an axicon for imposing an axicon phase distribution and a spiral phase plate for imposing a vortex phase distribution, or (iii) by a combination of the axicon for imposing the axicon phase distribution and a lobe-beam phase plate for imposing a lobe-beam phase distribution.

12. The method as claimed in claim 1, wherein:
the workpiece comprises a thin glass,
the laser pulse comprises an ultrashort pulse having pulse lengths of less than or equal to several picoseconds,
the workpiece has a thickness in the propagation direction of the incident laser beam of less than or equal to 2 mm, or
a material of the workpiece is substantially transparent to the laser beam.

13. The method as claimed in claim 1, furthermore comprising
effecting a relative movement between the workpiece and the laser beam in order to create an arrangement of microholes.

14. A diffractive optical beam-shaping element for imposing a phase distribution on a transverse beam profile of a laser beam, the diffractive optical beam-shaping element comprising:
surface elements that adjoin one another and form an areal grating structure, wherein each surface element is assigned a phase shift value, and the phase shift values define a two-dimensional phase distribution, wherein:
the two-dimensional phase distribution has a beam center position that defines a radial direction in the areal grating structure,
each phase shift value of the phase shift values forms periodic grating functionsthat has a same grating period in the radial direction with respect to a beam center position, and
each periodic grating function of the periodic grating functions is assigned a radial grating phase with respect to the beam center position, the radial grating phase is formed by a phase contribution that increases continuously in an azimuthal circumferential manner or varies between one or more values in azimuth angle sections.

15. The diffractive optical beam-shaping element as claimed in claim 14, wherein each periodic grating function of the periodic grating functions comprises a component of a sawtooth grating phase profile, a gradient of a region of increase in each of the sawtooth grating phase profiles corresponds to a predetermined axicon angle assigned to the diffractive optical beam-shaping element.

16. The diffractive optical beam-shaping element as claimed in claim 15, wherein the predetermined axicon angle is
in the range of from 0.5° to 40° for creation of a real Bessel-beam intermediate focus by the laser beam downstream in beam terms from the diffractive optical beam-shaping element, or
in the range of from (−0.5)° to (−40)° for taking as a basis a virtual Bessel-beam intermediate focus upstream in beam terms from the diffractive optical beam-shaping element.

17. The diffractive optical beam-shaping element as claimed in claim 14, wherein each periodic grating function of the periodic grating functions comprises a component of a two-dimensional focusing phase distribution that is radially symmetrical with respect to the beam center position.

18. A laser machining installation for machining a workpiece by a laser beam, the laser machining installation comprising:
a laser beam sourceconfigured to emit the laser beam,
an optical system that
has a diffractive optical beam-shaping element as claimed in claim 14, and
a machining head having a focusing lens,
wherein the diffractive optical beam-shaping element is arranged in a beam path of the laser beam in order to impose a two-dimensional phase distribution on the laser beam, to enable the laser beam to create a modification of a material of the workpiece, the modification delimiting a cylindrical body from a residual material surrounding the modification, and a wet-chemical etching bath for structurally separating the cylindrical body from the residual material.

19. The laser machining installation as claimed in claim 18, further comprising
a workpiece holder with provision of a relative positionability of the machining head.

20. The laser machining installation as claimed in claim 18, wherein the two-dimensional phase distribution is configured such that the annular transverse intensity distribution has one intensity zone running continuously around the propagation direction of the laser beam or multiple intensity zones restricted to azimuth angle regions around the propagation direction of the laser beam, and
the modification forms a continuous or interrupted circular ring, or a continuous or interrupted elliptical ring in a cross section perpendicular to the propagation direction of the laser beam.
